(19) United States
(12) Patent Application Publication
(10) Pub. No.: US 2026/0084904 A1
(43) Pub. Date: Mar. 26, 2026

(54) TRANSVERSE CONVEYOR FOR ROLLER TABLES

(71) Applicant: AMOVA GmbH, Hilchenbach (DE)

(72) Inventor: Carsten HEIDE, Netphen (DE)

(73) Assignee: AMOVA GmbH, Hilchenbach (DE)

(21) Appl. No.: 19/113,494

(22) PCT Filed: Oct. 20, 2023
(86) PCT No.: PCT/EP2023/079236

§ 371 Date: Mar. 20, 2025

(30) Foreign Application Priority Data
Nov. 2, 2022 (DE) 10 2022 128 965.6

(51) Int. Cl. B65G 47/64; B65G 13/00

(52) U.S. Cl. CPC B65G 47/641; B65G 13/00; B65G 2201/0223

(57) ABSTRACT

A transverse conveyor serves to transport of heavy loads from a first, horizontally extending roller conveyor table to a second, horizontally extending roller conveyor table. The transverse conveyor is designed and configured as a roller table segment and is designed to be inserted in a flush manner both into the first and in the second roller conveyor table. A device is provided for the transverse transport of the transverse conveyors between the roller conveyor tables. The device for the transverse transport of the transverse conveyors is configured and is designed to overcome a height difference between the first roller conveyor table and the second roller conveyor table.

### CROSS-REFERENCE TO RELATED APPLICATION

This application is a national stage application, filed under 35 U.S.C. § 371, of International Patent Application PCT/EP2023/079236, filed on Oct. 20, 2023, which claims the benefit of German Patent Application DE 10 2022 128 965.6, filed on Nov. 2, 2022.

### TECHNICAL FIELD

The disclosure relates to a transverse conveyor for roller tables for transporting heavy loads such as slabs or ingots, metal foils, metal sheets or coils made of metal material, or containers and other heavy goods.

### BACKGROUND

Roller tables for transporting heavy loads such as slabs or ingots, metal foils, metal sheets or coils and containers or the like are well known from the prior art.

For example, in casting-rolling installations in which slabs are cast in at least one casting machine and in a subsequent step are produced in a rolling mill for forming into thin strips or metal sheets, which are lastly wound up into coils, roller tables are the usual means of conveying and transporting the cast strand, any intermediate product and the finished rolled-out thin strip or metal sheet. Such slabs or ingots typically have a weight of more than 30 tons, in particular more than 35 tons, which can place large demands on the load-bearing capacity and heat stability and reliability of the roller tables.

In order to remove slabs, ingots, metal foils, metal sheets, coils, containers or the like from the roller conveyor table or, if necessary, to feed further slabs or ingots, metal foils, metal sheets, coils or containers onto the roller conveyor table, transverse conveyors are known from the prior art which are able to transversely convey roller conveyor table segments laterally to the extension direction of the roller table and to align them preferably flush with a second, likewise horizontally extending roller conveyor table, in order to then continue with the onward transport of the slabs or ingots, metal foils, metal sheets, coils or containers and the like.

In casting-rolling installations, in particular those using the CSP concept, this is all the more necessary since the capacity of the casting installation differs significantly from the capacity of the downstream rolling mill. Frequently, therefore, slabs or ingots are supplied from a storage facility laterally into the roller conveyor table upstream of the rolling mill or one rolling mill is fed simultaneously from two parallel casting installations. The transverse conveyors are then used to pick up slabs or ingots from the roller conveyor table, which is connected downstream of the respective casting machine, and to supply them into the roller conveyor table, which is connected upstream of the rolling mill.

Due to the large loads that have to be carried and moved safely by the roller conveyor tables and thus also by the transverse conveyor, extensive work was previously necessary to ensure that the transverse transport could take place horizontally and without topographical obstacles. In practice, therefore, extensive preparatory work was necessary to ensure horizontal transverse transport of a transverse conveyor, even if the topography of the installation or the installation layout did not actually provide for this. If the roller conveyor tables were unavoidably at different height levels and thus in different horizontal planes, hoists had to be provided to overcome the height difference. The transverse conveyor was then, usually after extensive preparatory work, transported horizontally by means of a transverse conveyor from the first roller conveyor table transversely to the hoist and then conveyed vertically by the hoist to the second roller conveyor table or, if necessary, to a further transverse conveyor for further horizontal movement.

The preparatory measures required for this are therefore considerable and the cycle rates achievable with such combinations of transverse conveyors and lifting tables are not satisfactory.

### SUMMARY

It was therefore the object of the disclosure to provide a transverse conveyor which can also be used when, owing to the topography of the installation or because of the layout for the installation, an exclusively horizontal transport from a first roller conveyor table to a second roller conveyor table is not possible. This object is solved with a transverse conveyor as disclosed and claimed.

A transverse conveyor for the transport of heavy loads from a first horizontally extending roller conveyor table to a second, likewise horizontally extending conveyor table is provided. The transverse conveyor is designed as a roller table segment and is configured and designed to be inserted in a flush manner both into the first and the second roller conveyor table. It includes a device for the transverse transport of the transverse conveyor between the roller conveyor tables. The device for the transverse transport of the transverse conveyor is configured and designed to overcome a height difference between the first roller conveyor table and the second roller conveyor table.

As a result, a transverse conveyor is provided which is able, independently of the topography or the installation layout, to bridge two roller conveyor tables, thus transport heavy loads from a first roller conveyor table to a second and back again, even if height differences have to be overcome in the process. A single device is provided for both the transverse transport and for overcoming the height difference.

Essential preparatory work can therefore be dispensed with, and the throughput of the transverse conveyor is significantly increased compared to the prior art devices which use a lifting table or the like to bring about horizontal transverse transport and vertical transport. Furthermore, the transverse conveyor is able to be integrated into the first and the second roller conveyor table, meaning that it is not difficult to remove a heavy load from the first roller conveyor table, transport it transversely by means of the transverse conveyor and then transport it further onto the second roller conveyor table.

It is particularly preferred if the device for the transverse transport is designed and configured to perform the transverse transport and to overcome the height difference in one movement, preferably a single, uninterrupted movement in a single direction. As a result, the transverse conveyor is implemented particularly simply and, furthermore, the travel path of the transverse conveyor and the heavy load placed thereon is kept to a minimum.

It is furthermore preferred if the height difference between the first and the second roller conveyor table causes a preferably constant gradient for the travel path of the transverse conveyor. Preferred is a gradient of at least 1°, preferably at least 4°, particularly preferably 4° to 10°, extremely preferably more than 10°, in particular 10° to 45°. This provides a transverse conveyor which is able to be optimally adapted to different topographies or height differences and furthermore is also able to safely overcome large hight differences without any problem.

It is particularly preferred if the device for the transverse transport is in operative connection with at least one rail, preferably two rails, to guide the transverse conveyor. This creates a transverse transport option in which the transverse transport of the transverse conveyor can be carried out safely and in a directed manner between the first roller conveyor table and the second roller conveyor table without any misalignments or deviations in the transverse transport arising. In particular, the alignment of the transverse conveyor both with the first roller conveyor table and the second roller conveyor table can therefore be implemented in a targeted manner.

In a further preferred embodiment, the device for the transverse transport has at least one driven wheel for transporting the transverse conveyor on at least one, preferably two, rails. Here, the gradient of the travel path should preferably be around 1° to 4°. A transverse conveyor is so provided which can use simple and manageable means to achieve slight gradients, either when there are large distances between the roller conveyor tables to be bridged by the transverse conveyor or when there is only a small height difference between the two roller conveyor tables. Owing to the Hertzian pressure between wheel and rail, a gradient of 1° to 4° can be safely achieved solely due to the frictional connection between the transverse conveyor and the rail.

In an alternative and likewise preferred embodiment, the device for the transverse transport has at least one driven pinion for transporting the transverse conveyor on at least one toothed rack or at least one drive rack. Here, the gradient of the travel path is preferably 4° to 10°. A transverse conveyor is thus provided which can be used if rail transport is no longer readily possible or only possible to a limited extent due to the gradient. The pinion, preferably a driven pinion, preferably meshes in a toothed rack or in a so-called drive rack arranged parallel to the rails, in which a sequence of teeth is not provided, but a plurality of cylinders arranged with a defined spacing from each other enable the engagement of a pinion meshing with the drive rack.

In a further alternative and similarly preferred embodiment, the device for the transverse transport comprises at least one hoist, comprising at least one cable for transporting the transverse conveyor, preferably a cable passing over at least one cable drum. Here, the gradient of the travel path is preferably more than 10°. A transverse conveyor is provided which is able to safely overcome even large gradients and, in the process, offers a simple and easily manageable means to overcome the height difference and for the simultaneous transverse transport. Particularly if the cable hoist has a plurality of cable drums or deflection rollers, using the block and tackle principle, the force expended for the transverse transport is significantly reduced.

In a further preferred embodiment, the device for the transverse transport is designed and configured to move at least two transverse conveyors between at least two roller conveyor tables, preferably simultaneously. It is particularly preferred if a third horizontally extending roller conveyor table is arranged between two roller conveyor tables, wherein the third roller conveyor table has a height difference with respect to the first and second roller conveyor table, preferably the same height difference. Here, the device for the transverse transport is designed and configured to transport a first transverse conveyor from the first roller conveyor table to the third roller conveyor table and simultaneously a second transverse conveyor from the third roller conveyor table to the second roller conveyor table. This provides a transverse conveyor which is able to provide a particularly high cycle rate when feeding the third roller conveyor table from the first and the second roller conveyor tables. Particularly if the third roller conveyor table is arranged higher than the first and the second roller conveyor tables, the energy expended when transporting a heavy load by means of a first transverse conveyor from the second roller conveyor table to the third roller conveyor table can be at least partially compensated for when the second transverse conveyor is moved back simultaneously from its position in front of the third roller conveyor table to its end position behind the second roller conveyor table. While the first transverse conveyor thus overcomes a height difference following the gradient upwards, the second transverse conveyor simultaneously moves downwards or preferably over the same height difference and possibly following a same gradient. As a result, the energy saved during the movement of the second transverse conveyor can be used to transport the first transverse conveyor.

It is moreover preferred if means for energy recovery are provided in order to store energy released during transverse transport and to use it as and when required.

It is preferred if the roller conveyor tables extend parallel to each other. Roller conveyor tables that are considered to be parallel in the context of the present application are those which do not cross and where deviations from an exact parallelism of around +/−10° do not disrupt the operation of the transverse conveyor.

In a preferred embodiment, the roller conveyor tables constitute part of a casting-rolling installation, wherein then the first and second roller conveyor tables and the transverse conveyor connect two casting machines to a rolling mill.

The heavy loads are, for example, slabs, ingots, metal foils, metal sheets or coils of metal material, as are customarily known in the steel or aluminium industry as semi-finished materials and machined products. The roller conveyor tables and transverse conveyor are able in principle to safely transport all starting materials and products as well as intermediate products even at high temperatures and high weights of, for example, more than 5 t, preferably more than 10 t, particularly preferably more than 15t. The transverse conveyor can also be employed for the transport of containers and/or goods with a weight of at least 5 t or more.

### BRIEF DESCRIPTION OF THE DRAWINGS

The invention is explained in more detail hereinbelow with reference to two figures from which preferred embodiments of the invention become apparent. The figures do not limit the scope of protection of the invention.

FIG. 1 shows a schematic view of two transverse conveyors, which each connect a first and a second roller conveyor table to a third roller conveyor table, and

FIG. 2 shows an enlarged part view of a driven pinion which meshes in a drive rack in order to drive a transverse conveyor.

### DETAILED DESCRIPTION

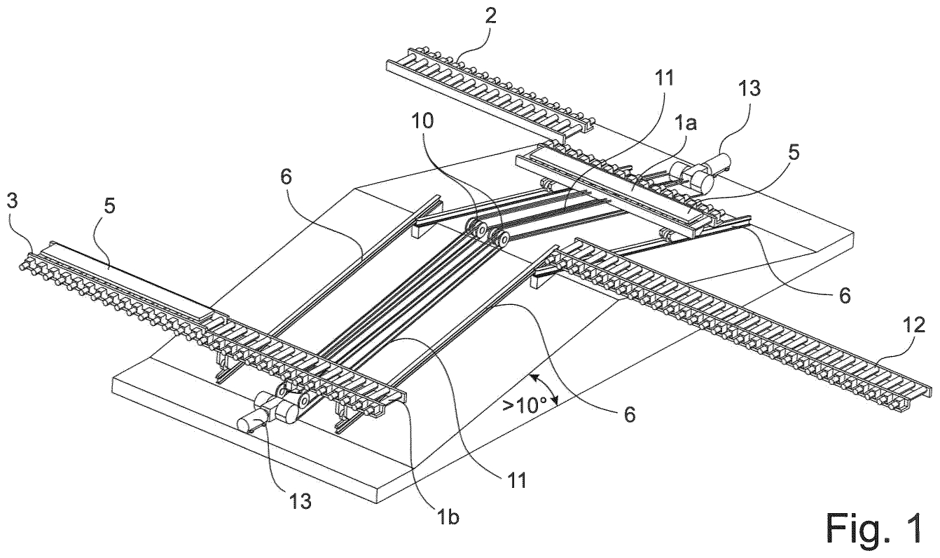

FIG. 1 shows two transverse conveyors 1a, 1b, wherein the first transverse conveyor 1a connects the first roller conveyor table 2 to the third roller conveyor table 12 and the second transverse conveyor 1b connects the second roller conveyor table 3 to the third roller conveyor table 12. The third roller conveyor table 12 is arranged higher than the first and second roller conveyor tables 2,3, so that the transverse conveyor 1a, 1b has to overcome a gradient of more than 10° when transporting the thin slabs 5 to the third roller conveyor table 12. The transverse conveyors 1a, 1b are designed as roller table segments, which can be fitted in to place flush behind the first and second roller conveyor tables 2,3 and in front of the third roller conveyor table 12 so that it is readily possible to transport the thin slab 5 both from the first and second roller conveyor tables 2,3 onto the transverse conveyor 1a, 1b and from the transverse conveyors 1a, 1b onto the third roller conveyor table 12. The transverse conveyors 1a, 1b travel between the roller conveyor tables 2,3,12 on rails 6 in order to guarantee safe transport of the thin slabs 5 on the transverse conveyors 1a, 1b and a flush alignment of the transverse conveyors 1a, 1b with the roller conveyor tables 2,3,12. A cable 11 is used for the transverse transport of the transverse conveyor 1a, 1b and is connected to a motor 13 and the respective transverse conveyor 1a, 1b. The cable 11 extends around cable drums or deflection rollers 10, so that the force applied at the time of transversely transporting the thin slabs 5 can be kept low. In the arrangement shown here of transverse conveyors 1a, 1b and three roller conveyor tables 2,3,12, the thin slabs 5 are transported by means of the first transverse conveyor 1a from the first roller conveyor table 2 to the third roller conveyor table 12 following the gradient upwards, while, preferably at the same time, the second transverse conveyor 1b travels from the third roller conveyor table 12, following the gradient of the travel path downwards, into its position behind the second roller conveyor table 3 in order to pick up a new heavy load there, for example in the form of a further thin slab 5.

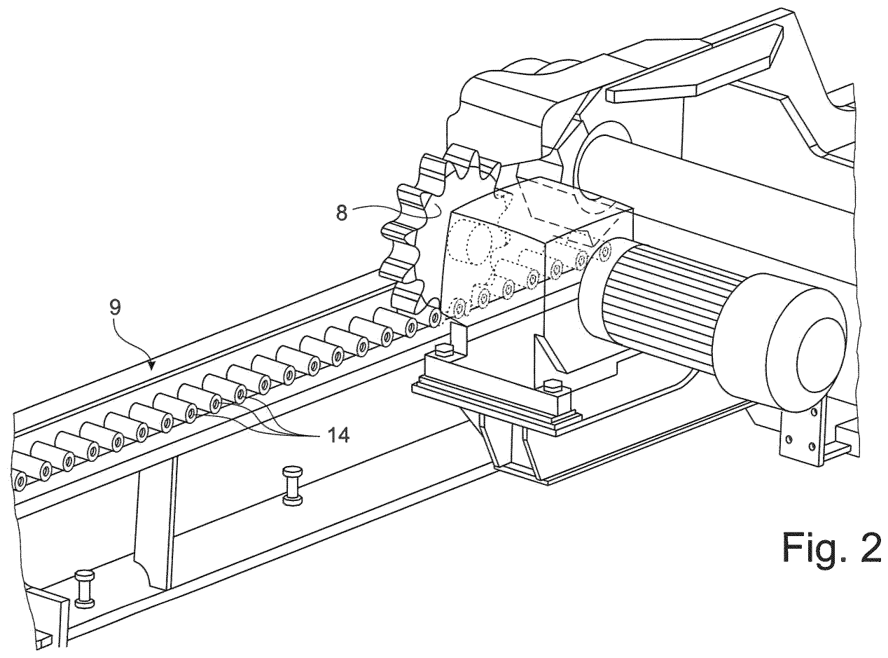

FIG. 2 shows a detail view of a conveyor drive for a transverse conveyor (not shown), comprising a pinion 8 which is connected to a drive (not shown) and meshes in a drive rack 9 in order to move the transverse conveyor (not shown) forwards and backwards along the drive rack 9. The drive rack consists of a plurality of cylinders 14 arranged at a predefined distance from each other on a rail or the like, with the teeth of the pinion 8 dipping into the clearance between the cylinders 14, thereby causing the transverse conveyor (not shown) to be driven forwards.

### LIST OF REFERENCE NUMERALS

1 transverse conveyor
2 first roller conveyor table
3 second roller conveyor table
4 device for the transverse transport
5 heavy loads
6 rails
8 pinion
9 drive rack
10 cable drum
11 cable
12 third roller conveyor table
13 motor
14 drive rack cylinder

1.-14. (canceled)

15. A transverse conveyor for transporting heavy loads from a first horizontally extending roller conveyor table to a second horizontally extending roller conveyor table, comprising:
a roller table segment configured to be inserted in a flush manner into the first horizontally extending roller conveyor table and the second horizontally extending roller conveyor table, and
a device for transversely transporting the roller table segment between the first horizontally extending roller conveyor table and the second horizontally extending roller conveyor table,
wherein the device is configured to overcome a height difference between the first horizontally extending roller conveyor table and the second horizontally extending roller conveyor table.

16. The transverse conveyor according to claim 15,
wherein the device is configured to perform a transverse transport and to overcome the height difference in a single, uninterrupted movement in a single direction.

17. The transverse conveyor according to claim 15,
wherein the height difference between the first horizontally extending roller conveyor table and the second horizontally extending roller conveyor table causes a gradient for a travel path of the roller table segment to be between 10° and 45°.

18. The transverse conveyor according to claim 15,
wherein the device is in operative connection with two rails to guide the roller table segment.

19. The transverse conveyor according to claim 15,
wherein the device has at least one driven wheel for transporting the roller table segment on two rails, and
wherein a gradient of a travel path of the roller table segment is 1° to 4°.

20. The transverse conveyor according to claim 15,
wherein the device has at least one driven pinion for transporting the roller table segment on at least one toothed rack or at least one drive rack,
wherein a gradient of a travel path of the roller table segment is 4° to 10°.

21. The transverse conveyor according to claim 15,
wherein the device has at least one hoist, comprising a cable passing over a cable drum for transporting the roller table segment, and
wherein a gradient of a travel path of the roller table segment is more than 10°.

22. The transverse conveyor according to claim 15,
further comprising a further roller table segment,
wherein the device is configured to move the roller table segment and the further roller table segment simultaneously.

23. The transverse conveyor according to claim 22,
wherein a third horizontally extending roller conveyor table is arranged between the first horizontally extending roller conveyor table and the second horizontally extending roller conveyor table,
wherein the third horizontally extending roller conveyor table has a height difference with respect to the first horizontally extending roller conveyor table and the second horizontally extending roller conveyor table,
wherein the device is configured to transport the roller table segment from the first horizontally extending roller conveyor table to the third horizontally extending roller conveyor table and simultaneously transport the further roller table segment from the third horizontally extending roller conveyor table to the second horizontally extending roller conveyor table.

24. The transverse conveyor according to claim 16,
further comprising means for energy recovery configured to store energy released during the transverse transport.

25. The transverse conveyor according to claim 22,
wherein the roller table segment and the further roller table segment are transported simultaneously, and
wherein energy released during transporting the roller table segment is used for transporting the further roller table segment.

26. The transverse conveyor according to claim 15,
wherein the first horizontally extending roller conveyor table and the second horizontally extending roller conveyor table extend parallel to each other.

27. The transverse conveyor according to claim 15,
wherein the transverse conveyor is part of a casting-rolling installation, and wherein the transverse conveyor connects two casting machines to a rolling mill.

28. The transverse conveyor (1) according to claim 15,
wherein the heavy loads are slabs, ingots, metal foils, metal sheets, coils of metal material, containers, and/or goods with a weight of at least 5 tons.
